(19) United States
(12) Patent Application Publication
(10) Pub. No.: US 2022/0398366 A1
(43) Pub. Date: Dec. 15, 2022

(54) Nonlinear Model Modeling Method, Device and Storage Medium

(71) Applicant: Siemens Aktiengesellschaft, Beijing (DE)

(72) Inventors: De Hui Wang, Beijing (CN); Ning Jiang, Beijing (CN); Tuo Zhang, Beijing (CN); Zhong Wei Tian, Beijing (CN)

(73) Assignee: Siemens Aktiengesellschaft, Beijing (DE)

(21) Appl. No.: 17/765,064

(22) PCT Filed: Sep. 30, 2019
(86) PCT No.: PCT/CN2019/109674

§ 371 Date: Mar. 30, 2022

(51) Int. Cl. G06F 30/27; G06N 20/00; G05B 17/02

(52) U.S. Cl. CPC G06F 30/27; G06N 20/00; G05B 17/02

(57) ABSTRACT

Various embodiments of the teachings herein include a nonlinear model modeling method. The method may include: determining complete design point data for each of multiple target nonlinear underlying process of multiple types of equipment; establishing a descriptive formula of the process with the ratio of a similarity parameter supported by a similarity criterion to a similarity parameter based on design point data, to obtain a universal model of the process; constructing a machine learning algorithm between the parameter of the actual working condition and the variable parameter and establishing a correlation between the machine learning algorithm and the universal model; and taking the universal models of all the target nonlinear underlying processes of each type of equipment and the correlated machine learning algorithms as a universal model of the type of equipment. The universal model comprises a variable parameter that changes as a parameter of an actual working condition changes.

### CROSS-REFERENCE TO RELATED APPLICATIONS

This application is a U.S. National Stage Application of International Application No. PCT/CN2019/109674 filed Sep. 30, 2019, which designates the United States of America, the contents of which is hereby incorporated by reference in their entirety.

### TECHNICAL FIELD

The present disclosure relates to the industrial field. Various embodiments of the teachings herein may include nonlinear model modeling methods, devices, and/or computer-readable storage media in integrated energy systems.

### BACKGROUND

Distributed energy systems (DESs) are considered as one of the effective ways to address the unstable consumption of renewable energies. DESs are being built all over the world, including China, and there is an increasing demand for models used for operational optimization and for overall scheduling of the systems in terms of energy production and utilization. Previous researchers have developed specific models for operational optimization that are only applicable to systems with specific energy sources and components. Thus, their models do not meet the requirements of the emerging integrated energy services in practical implementation.

Therefore, it is necessary to provide a universal integrated energy system, to make full use of renewable energies, fossil fuels, residual heat and pressure, new energies and other forms of resources, so that they can supplement each other, and to establish innovative business models through the flexible operation of energy sources, the grid, loads and energy storage facilities, to achieve high-quality, high-efficiency, and the most economical integrated regional supply power, heating, cooling, gas, etc. to various loads with good environmental effects through the use of smart means, so that the requirements of random changes in the terminal loads are met. Integrated energy systems promote the consumption capacity of renewable energies and improve the overall utilization rate of energy.

However, in the process of implementing an integrated energy system as above, models need to be established for a lot of equipment, which usually incorporates many nonlinear physical processes (also called underlying processes), such as the processes related to flow and pressure in the compressor of a gas turbine, the process of converting mechanical energy into pressure energy, etc., and thus the models of such equipment are generally nonlinear models. How to establish these nonlinear models has become an urgent problem to be solved at present.

### SUMMARY

In this disclosure, nonlinear model modeling methods, nonlinear model modeling devices, and/or computer-readable storage media may be used for the nonlinear model modeling of some models comprising nonlinear underlying processes, which are then used for the establishment of platforms for integrated energy systems.

For example, some embodiments include a nonlinear model modeling method comprising: determining complete design point data for each target nonlinear underlying process of each type of equipment; establishing a descriptive formula of a nonlinear underlying process through the use of the ratio of a similarity parameter supported by a similarity criterion to a similarity parameter based on the design point data, to obtain a universal model of the nonlinear underlying process, wherein the universal model comprises a variable parameter that changes nonlinearly as a parameter of an actual working condition changes; constructing a machine learning algorithm between the parameter of the actual working condition and the variable parameter, and establishing a correlation between the machine learning algorithm and the universal model; and taking the universal models of all the target universal nonlinear processes of each type of equipment and the correlated machine learning algorithms as a universal model of a type of equipment.

In some embodiments, the method further comprises: for each target nonlinear underlying process of one specific piece of equipment of the type of equipment, obtaining historical data of the parameter of the actual working condition and the variable parameter corresponding to the target nonlinear underlying process of the specific piece of equipment, and using the historical data to train the machine learning algorithm, to obtain a training model of the variable parameter of the target nonlinear underlying process; substituting the training model of the variable parameter of the target nonlinear underlying process into the universal model of the target nonlinear underlying process, to obtain a trained model of the target nonlinear underlying process of the specific piece of equipment; and taking the trained models of all the target nonlinear underlying processes of the specific piece of equipment as a trained model of the specific piece of equipment.

In some embodiments, the variable parameter has a preset default value.

In some embodiments, the equipment includes: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, and boilers; the target nonlinear underlying processes of each type of equipment include one or more of the following processes: a heat transfer process, a process of converting electric energy to thermal energy, a chemical process of separating solution substances by use of high-temperature thermal energy, an electrochemical process, a process of pipeline resistance, a process related to flow and pressure, a process of converting thermal energy to mechanical energy, a process of converting electric energy to cold or heat energy, a rectification process, an evaporation process and a filtration process.

In some embodiments, a nonlinear model modeling device comprises: a determining module, used to determine complete design point data for each target nonlinear underlying process of each type of equipment; an establishing module, used to establish a descriptive formula of a nonlinear underlying process through the use of the ratio of a similarity parameter supported by a similarity criterion to a similarity parameter based on the design point data, to obtain a universal model of the nonlinear underlying process, wherein the universal model comprises a variable parameter that changes nonlinearly as a parameter of an actual working condition changes; a machine learning module, used to construct a machine learning algorithm between the parameter of the actual working condition and the variable parameter, and establish a correlation between the machine learning algorithm and the universal model; and a packaging module, used to package the universal models of all the target universal nonlinear processes of each type of equipment and the correlated machine learning algorithms as a universal model of a type of equipment.

In some embodiments, the device further comprises: a training module, used to, for each target nonlinear underlying process of one specific piece of equipment of the type of equipment, obtain historical data of the parameter of the actual working condition and the variable parameter corresponding to the target nonlinear underlying process of the specific piece of equipment, and use the historical data to train the machine learning algorithm, to obtain a training model of the variable parameter of the target nonlinear underlying process; and a substituting module, which inputs the training model of the variable parameter of the target nonlinear underlying process into the universal model of the target nonlinear underlying process, to obtain a trained model of the target nonlinear underlying process of the specific piece of equipment, wherein the trained models of all the target nonlinear underlying processes of the specific piece of equipment constitute a trained model of the specific piece of equipment.

In some embodiments, the variable parameter has a preset default value.

In some embodiments, the equipment includes: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, and boilers; the target nonlinear underlying processes of each type of equipment include one or more of the following processes: a heat transfer process, a process of converting electric energy to thermal energy, a chemical process of separating solution substances by use of high-temperature thermal energy, an electrochemical process, a process of pipeline resistance, a process related to flow and pressure, a process of converting thermal energy to mechanical energy, a process of converting electric energy to cold or heat energy, a rectification process, an evaporation process and a filtration process.

As another example, some embodiments include a nonlinear model modeling device comprising: at least one memory and at least one processor, wherein: the at least one memory is used to store a computer program; the at least one processor is used to call the computer program stored in the at least one memory, to execute the nonlinear model modeling method described in any of the above implementations.

As another example, some embodiments include a computer-readable storage medium with a computer program stored thereon; the computer program can be executed by a processor and implement the nonlinear model modeling method described in any of the above implementations.

### BRIEF DESCRIPTION OF THE DRAWINGS

The various embodiments of the teachings of the present disclosure are described in detail below with reference to the drawings, so that those skilled in the art will better understand the above and other features and advantages of various embodiments. In the drawings:

FIG. 1 is an exemplary flowchart of a nonlinear model modeling method incorporating teachings of the present disclosure;

FIG. 2 is an exemplary flowchart of another nonlinear model modeling method incorporating teachings of the present disclosure;

FIG. 3 is an exemplary structural diagram of a nonlinear model modeling device incorporating teachings of the present disclosure; and

FIG. 4 is an exemplary flowchart of another nonlinear model modeling device incorporating teachings of the present disclosure.

In the drawings, the following reference numerals are used:

| Numeral | Meaning |
|---|---|
| 101-104, 201-203 | Steps |
| 301 | Determining module |
| 302 | Establishing module |
| 303 | Machine learning module |
| 304 | Packaging module |
| 305 | Training module |
| 306 | Substituting module |
| 41 | Memory |
| 42 | Processor |
| 43 | Bus |

### DETAILED DESCRIPTION

It can be seen from the solution described above that a universal model of a nonlinear underlying process is obtained by establishing a descriptive formula of the nonlinear underlying process through the use of the ratio of a similarity parameter supported by a similarity criterion to a similarity parameter based on design point data for each target nonlinear underlying process of each type of equipment, the model is applicable to one type of equipment as a universal model. Moreover, the universal model comprises a variable parameter that changes nonlinearly as a parameter of the actual working condition changes, and the variable parameter can be obtained by machine learning through establishing a machine learning algorithm between the parameter of the actual working condition and the variable parameter, so that the universal model is capable of self-learning.

Furthermore, for one specific piece of equipment of the type of equipment, historical data of the parameter of the actual working condition and the variable parameter corresponding to a target nonlinear underlying process of the specific piece of equipment can be obtained for each target nonlinear underlying process, and the historical data is used to train the machine learning algorithm, to obtain a training model of the variable parameter of the target nonlinear underlying process; the training model of the variable parameter of the target nonlinear underlying process is substituted into the universal model of the target nonlinear underlying process, to obtain a trained model of the target nonlinear underlying process of the specific piece of equipment, i.e., an instantiated model conforming to the characteristics of the specific piece of equipment.

In addition, by setting the default value of the variable parameter in advance, it is possible to make the nonlinear model available where site conditions do not permit training the variable parameter, for example, when there is not enough historical data, etc.

Lastly, the modeling method in the embodiments of the present invention may be applied to various nonlinear processes of different types of equipment, with easy implementation and high accuracy. The following example embodiments will further illustrate the teachings of the present disclosure in detail in order to clarify its purpose, technical solution and advantages.

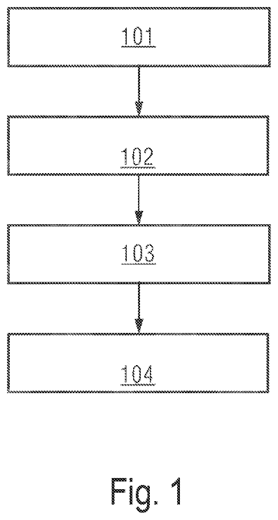

FIG. 1 is a flowchart of an example modeling method for nonlinear models incorporating teachings of the present disclosure. As shown in FIG. 1, the method may comprise:

Step 101, determining complete design point data for each target nonlinear underlying process of each type of equipment. In this step, an underlying process may sometimes be referred to as a physical process, for example, a heat transfer process, a process for converting electric energy, a process related to flow and pressure as mentioned previously, etc. For each device, the underlying processes of interest can be determined, i.e., the underlying processes that need to be modeled. These underlying processes that need to be modeled are referred to as target underlying processes, and those nonlinear target underlying processes can be referred to as target nonlinear underlying processes.

For example, for gas turbines, the target nonlinear underlying processes may include: a process related to flow and pressure in the expansion turbine, a process of energy conversion between thermal energy and mechanical energy, etc.; for heat pumps, the target nonlinear underlying processes may include: a heat transfer process, a process of converting electrical energy to thermal energy, a chemical process of separating solution substances through the use of high-temperature thermal energy, an electrochemical process, a pipeline resistance process, a process related to flow and pressure, etc. In addition, for equipment such as gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, boilers, etc., the target nonlinear underlying processes of each piece of equipment may include one or more of the following: a process related to flow and pressure, a process of converting thermal energy to mechanical energy, a process of converting electric energy to cold or heat energy, a process of pipeline resistance, a heat transfer process, a rectification process, an evaporation process, a filtration process, a chemical reaction process, an electrochemical process, etc.

For each nonlinear underlying process, the complete design point data can be restored according to the published basic design parameters and the common design point information provided to the user by the manufacturer. For example, for a universal model of a process related to flow and pressure, its design point data may comprise the pressure ratio, air flow, etc., and, based on these design point data, relevant design parameters not available to users can be derived, such as the efficiency, inlet resistance, air extraction volume, etc.

Step 102, establishing a descriptive formula of the nonlinear underlying process by use of the ratio of a similarity parameter supported by a similarity criterion to a similarity parameter based on design point data, to obtain a universal model of the nonlinear underlying process; wherein the universal model comprises a variable parameter that changes as a parameter of an actual working condition changes. In this step, a parameter of an actual working condition refers to a parameter of a specific piece of equipment that changes as the parameters of the actual working condition change. For example, it may be a dimension that changes as mechanical wear occurs after prolonged use, or the temperature that changes as the season changes, or relevant parameters that change as the working condition varies. The variable parameter may have a preset default value.

Since there may be different models for each type of equipment, for example, there may be compressors with different powers such as 5M, 50M, 500M, etc., in order to establish a universal model of compressors, it is necessary to adopt a similarity criterion to support a similarity parameter to replace a specific parameter value. For example, still taking the universal model of the above process related to flow and pressure as an example, the similarity parameters supported by the similarity criteria of flow, pressure and power are used instead of the specific parameters. For example, the similarity criteria of flow may be expressed by formula (1) below:

$$\frac{G 1 \sqrt{T 1}}{\frac{P 1}{\frac{G 0 \sqrt{T 0}}{P 0}}} \qquad ( 1 )$$

where G1 is the flow, T1 is the temperature, P1 is the pressure, G0 is the flow of the corresponding deign point, T0 is the temperature of the corresponding design point, and P0 is the pressure of the corresponding design point.

Accordingly, the universal model of a process related to flow and pressure may be expressed by formula (2) below:

$$\frac{G 1 \sqrt{T 1}}{\frac{P 1}{\frac{G 0 \sqrt{T 0}}{P 0}}}$$

where f( ) is a function, coefficients a and b are variable parameters that change as the parameters of the actual working condition change, and in practical application, a default value may be set for the variable parameters a and b. IGV is the angle of the inlet adjustable guide vane.

Step 103, constructing a machine learning algorithm between the parameter of the actual working condition and the variable parameter. In this step, a machine learning algorithm between the parameter of the actual working condition and the variable parameter may be constructed based an intelligent neural network or a method supporting big data analysis for machine learning such as vector machines, etc.

Step 104, taking the universal models of all the target nonlinear underlying processes of each type of equipment and the correlated machine learning algorithms as a universal model of the type of equipment. It can be seen that a nonlinear universal model can be established for each type of equipment through the above process. An integrated energy system platform can be constructed based on these universal models.

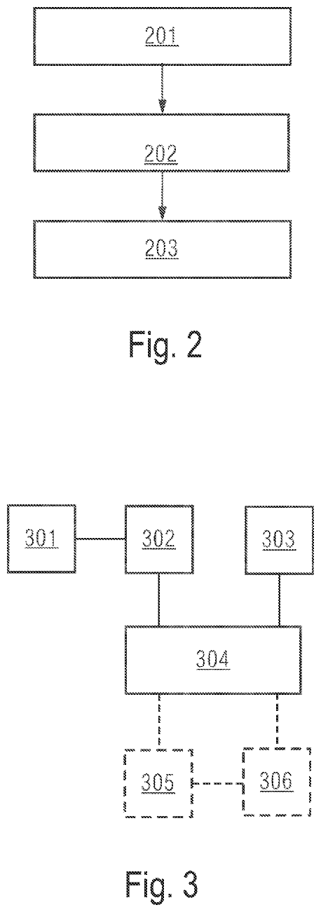

In practical application, after purchasing the integrated energy system platform, the user needs to build their own integrated energy system. At this point, each universal model needs to be associated with specific equipment on site, and thus the universal models need to be instantiated. Accordingly, the method may further comprise, as shown in FIG. 2:

Step 201, for each target nonlinear underlying process of one specific piece of equipment of the type of equipment, obtaining historical data of the parameter of the actual working condition and the variable parameter corresponding to the target nonlinear underlying process of the specific piece of equipment, and using the historical data to train the corresponding machine learning algorithm, to obtain a training model of the variable parameter of the target nonlinear underlying process. In this step, during specific training, a set of historical data of the parameter of the actual working condition is used as input sample values, the historical data of the variable parameter corresponding to the set of historical data of the parameter of the actual working condition is used as output sample values, and a large number of input sample values and the corresponding output sample values are used to train the machine learning algorithm, to obtain a self-learning model of the variable parameter, also referred to as a training model.

For example, still taking the abovementioned process related to flow and pressure as an example, the historical data of the relevant parameters of the actual working condition of a gas turbine on site and the historical data of the corresponding variable parameters can be obtained, to obtain the input and output sample sets, and a trained model of the variable parameters a and b can be obtained through training.

Step 202, substituting the training model of the variable parameter of the target nonlinear underlying process into the universal model of the target nonlinear underlying process, to obtain a trained model of the target nonlinear underlying process of the specific piece of equipment. The trained model is a self-learning model capable of learning. In this step, according to the correlation between the machine learning algorithm and the universal model, the training model of the variable parameter of the target nonlinear underlying process can be substituted into the universal model of the target nonlinear underlying process.

For example, still taking the abovementioned process related to flow and pressure as an example, by inputting the current training model of the variable parameters a and b into formula (2) above, the universal model of the process related to flow and pressure of the compressor of the gas turbine on site can be obtained.

Step 203, taking the trained models of all the target nonlinear underlying processes of the specific piece of equipment as a universal model of the specific piece of equipment. In actual use, the input parameters of the trained model may include the input parameters required for the trained models of all the target nonlinear underlying processes.

The nonlinear model modeling method in these embodiments is described in detail above, and the nonlinear model modeling device will be described in detail below. The nonlinear model modeling device in the embodiments of the present invention can be used to implement the nonlinear model modeling method incorporating teachings of the present disclosure. Details not disclosed in the device embodiments of the present invention can be found in the corresponding description of the method embodiments and will not be detailed here.

FIG. 3 is an exemplary structural diagram of a nonlinear model modeling device incorporating teachings of the present disclosure. As shown in FIG. 3, the device may be one that is shown by the solid lines in FIG. 3, which comprises: a determining module 301, an establishing module 302, a machine learning module 303 and a packaging module 304. Among these, the determining module 301 is used to determine complete design point data for each target nonlinear underlying process of each type of equipment.

The equipment may include: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, boilers, etc.; the target nonlinear underlying processes of each type of equipment may include one or more of the following processes: a heat transfer process, a process of converting electric energy to thermal energy, a chemical process of separating solution substances by use of high-temperature thermal energy, an electrochemical process, a pipeline resistance process, a process related to flow and pressure, a process of converting thermal energy to mechanical energy, a process of converting electric energy to cold or heat energy, a rectification process, an evaporation process, a filtration process, etc.

The establishing module 302 is used to establish a descriptive formula of the nonlinear underlying process by use of the ratio of a similarity parameter supported by a similarity criterion to a similarity parameter based on design point data, to obtain a universal model of the nonlinear underlying process; wherein the universal model comprises a variable parameter that changes as a parameter of an actual working condition changes. The variable parameter may have a preset default value.

The machine learning module 303 constructs a machine learning algorithm between the parameter of the actual working condition and the variable parameter, and establishes a correlation between the machine learning algorithm and the universal model.

The packaging module 304 is used to pack the universal models of all the target nonlinear underlying processes of each type of equipment and the correlated machine learning algorithms as a universal model of the type of equipment.

To instantiate the above universal models, the nonlinear model modeling device may be one that is shown by the dotted lines in FIG. 3, and further comprises: a training module 305 and a substituting module 306. Between them, the training module 305 is used to, for each target nonlinear underlying process of one specific piece of equipment of the type of equipment, obtain historical data of the parameter of the actual working condition and the variable parameter corresponding to the target nonlinear underlying process of the specific piece of equipment, and use the historical data to train the machine learning algorithm, to obtain a training model of the variable parameter of the target nonlinear underlying process.

The substituting module 306 inputs the training model of the variable parameter of the target nonlinear underlying process into the universal model of the target nonlinear underlying process, to obtain a trained model of the target nonlinear underlying process of the specific piece of equipment. The trained models of all the target nonlinear underlying processes of the specific piece of equipment constitute a universal model of the specific piece of equipment.

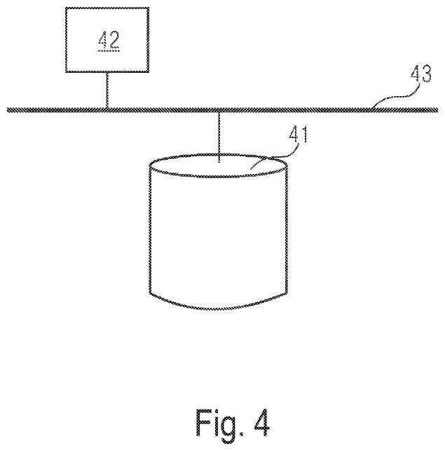

FIG. 4 is a schematic structural diagram of another nonlinear model modeling device incorporating teachings of the present disclosure. As shown in FIG. 4, the system may comprise: at least one memory 41 and at least one processor 42. In addition, some other components, for example, communication ports, etc., may also be comprised. These components communicate via a bus 43.

Specifically, the at least one memory 41 is used to store a computer program. In some embodiments, the computer program may be understood as comprising each of the modules of the nonlinear model modeling device as shown in FIG. 3. In addition, the at least one memory 41 may also store an operating system, etc. The operating system may be but is not limited to: an Android operating system, a Symbian operating system, a Windows operating system, a Linux operating system, etc.

The at least one processor 42 is used to call the computer program stored in the at least one memory 41 to execute the nonlinear model modeling method described in the embodiments of the present invention. The processor 42 may be a CPU, a processing unit/module, an ADIC, a logic module, a programmable gate array, etc. It can receive and send data through the communication ports.

It should be noted that not all steps and modules in the above flowcharts and structural diagrams are necessary, and some steps or modules can be ignored based on actual needs. The sequence of execution of the steps is not fixed, and can be adjusted as needed. A functional division of the modules is used only to facilitate the description. In actual implementation, a module may be implemented by multiple modules, and the functions of multiple modules may be implemented by a single module. These modules may be located in a single device or in different devices.

The hardware modules in each embodiment above may be implemented mechanically or electronically. For example, a hardware module may comprise specially designed permanent circuits or logic devices (for example, dedicated processors, such as FPGA or ASIC) to complete specific operations. A hardware module may also comprise programmable logic devices or circuits temporarily configured by software (for example, general-purpose processors or other programmable processors) for performing specific operations. Whether to specifically use mechanical methods or dedicated permanent circuits or temporarily configured circuits (such as software configuration) to implement hardware modules may be determined according to cost and schedule considerations.

Moreover, in some embodiments, a computer-readable storage medium has a computer program stored thereon, which can be executed by a processor and implement the nonlinear model modeling method incorporating teachings of the present disclosure. Specifically, a system or device equipped with a storage medium may be provided, and the software program code for implementing the functions of any of the above implementations is stored on the storage medium, so that a computer (or CPU or MPU) of the system or device reads and executes the program code stored in the storage medium.

In addition, the operating system operating on the computer may also be used to perform part or all of the actual operations through instructions based on the program code. It is also possible to write the program code read from the storage medium to the memory provided in an expansion board inserted into the computer or to the memory provided in an expansion unit connected to the computer, and then the program code-based instructions cause the CPU, etc. mounted on the expansion board or the expansion unit to perform part and all of the actual operations, so as to implement the functions of any of the above embodiments. Implementations of the storage media used to provide the program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROMs. Optionally, the program code may be downloaded from a server computer via a communication network.

It can be seen from the above solutions that, since a universal model of a nonlinear underlying process is obtained by establishing a descriptive formula of the nonlinear underlying process by use of the ratio of a similarity parameter supported by a similarity criterion to a similarity parameter based on design point data for each target nonlinear underlying process of each type of equipment, the model is applicable to one type of equipment as a universal model. Moreover, the universal model comprises a variable parameter that changes nonlinearly as a parameter of the actual working condition changes, and the variable parameter can be obtained by machine learning through establishing a machine learning algorithm between the parameter of the actual working condition and the variable parameter, so that the universal model is capable of self-learning.

Furthermore, for one specific piece of equipment of the type of equipment, historical data of the parameter of the actual working condition and the variable parameter corresponding to a target nonlinear underlying process of the specific piece of equipment can be obtained for each target nonlinear underlying process, and the historical data is used to train the machine learning algorithm, to obtain a training model of the variable parameter of the target nonlinear underlying process; the training model of the variable parameter of the target nonlinear underlying process is substituted into the universal model of the target nonlinear underlying process, to obtain a trained model of the target nonlinear underlying process of the specific piece of equipment, i.e., an instantiated model conforming to the characteristics of the specific piece of equipment.

In addition, by setting the default value of the variable parameter in advance, it is possible to make the nonlinear model available where site conditions do not permit training the variable parameter, for example, when there is not enough historical data, etc.

Lastly, the modeling method incorporating teachings of the present disclosure may be applied to various nonlinear processes of different types of equipment, with easy implementation and high accuracy.

The above are only example embodiments of the present disclosure, and are not intended to limit the scope of the present disclosure. Any modification, equivalent replacement and improvement made without departing from the motivation and principle of the present disclosure shall be included in its scope.

What is claimed is:

1. A nonlinear model modeling method, the method comprising:
determining complete design point data for each of multiple target nonlinear underlying process of multiple types of equipment;
establishing a descriptive formula of the nonlinear underlying process using a ratio of a similarity parameter supported by a similarity criterion to a similarity parameter based on design point data, to obtain a universal model of each nonlinear underlying process;
wherein the universal model comprises a variable parameter that changes as a parameter of an actual working condition changes;
constructing a machine learning algorithm between the parameter of the actual working condition and the variable parameter and establishing a correlation between the machine learning algorithm and the universal model; and
taking the universal models of all the target nonlinear underlying processes of each type of equipment and the correlated machine learning algorithms as a universal model of the type of equipment.

2. The nonlinear model modeling method as claimed in claim 1, further comprising:
for each target nonlinear underlying process of one specific piece of equipment of the type of equipment, obtaining historical data of the parameter of the actual working condition and the variable parameter corresponding to the target nonlinear underlying process of the specific piece of equipment, and using the historical data to train the machine learning algorithm, to obtain a training model of the variable parameter of the target nonlinear underlying process;
substituting the training model of the variable parameter of the target nonlinear underlying process into the universal model of the target nonlinear underlying process, to obtain a trained model of the target nonlinear underlying process of the specific piece of equipment; and
taking the trained models of all the target nonlinear underlying processes of the specific piece of equipment as a universal model of the specific piece of equipment.

3. The nonlinear model modeling method as claimed in claim 1, wherein the variable parameter has a preset default value.

4. The nonlinear model modeling method as claimed in claim 1, wherein:
the equipment includes: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, and boilers; and
the target nonlinear underlying processes of each type of equipment include one or more of the following processes:
a heat transfer process, a process of converting electric energy to thermal energy, a chemical process of separating solution substances by use of high-temperature thermal energy, an electrochemical process, a process of pipeline resistance, a process related to flow and pressure, a process of converting thermal energy to mechanical energy, a process of converting electric energy to cold or heat energy, a rectification process, an evaporation process, and a filtration process.

5. A nonlinear model modeling device comprising:
a determining module determining complete design point data for each target nonlinear underlying process of multiple types of equipment;
an establishing module establishing a descriptive formula of the nonlinear underlying process by use of the ratio of a similarity parameter supported by a similarity criterion to a similarity parameter based on design point data, to obtain a universal model of the nonlinear underlying process;
wherein the universal model comprises a variable parameter that changes as a parameter of an actual working condition changes;
a machine learning module constructing machine learning algorithm between the parameter of the actual working condition and the variable parameter and establishing a correlation between the machine learning algorithm and the universal model; and
a packaging module packaging the universal models of all the target nonlinear underlying processes of each type of equipment and the correlated machine learning algorithms as a universal model of the type of equipment.

6. The nonlinear model modeling device as claimed in claim 5, further comprising:
a training module for each target nonlinear underlying process of one specific piece of equipment of the type of equipment, obtaining historical data of the parameter of the actual working condition and the variable parameter corresponding to the target nonlinear underlying process of the specific piece of equipment, and use the historical data to train the machine learning algorithm, to obtain a training model of the variable parameter of the target nonlinear underlying process; and
a substituting module submitting the training model of the variable parameter of the target nonlinear underlying process into the universal model of the target nonlinear underlying process, to obtain a trained model of the target nonlinear underlying process of the specific piece of equipment;
wherein the trained models of all the target nonlinear underlying processes of the specific piece of equipment constitute a trained model of the specific piece of equipment.

7. The nonlinear model modeling device as claimed in claim 5, wherein the variable parameter has a preset default value.

8. The nonlinear model modeling device as claimed in claim 5, wherein:
the equipment includes: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, and boilers; and
the target nonlinear underlying processes of each type of equipment include one or more of the following processes: a heat transfer process, a process of converting electric energy to thermal energy, a chemical process of separating solution substances by use of high-temperature thermal energy, an electrochemical process, a process of pipeline resistance, a process related to flow and pressure, a process of converting thermal energy to mechanical energy, a process of converting electric energy to cold or heat energy, a rectification process, an evaporation process and a filtration process.

9. A nonlinear model modeling device comprising:
a memory; and
a processor;
wherein
the memory stores a computer program; and
the processor calls the computer program stored in the memory to execute the nonlinear model modeling method claimed in claim 1.

10. (canceled)
